(19) United States
(12) Patent Application Publication
(10) Pub. No.: US 2005/0020101 A1
(43) Pub. Date: Jan. 27, 2005

(54) Contact and socket using with the contact

(76) Inventor: Limin Deng, Taipei (TW)

Correspondence Address: LIMIN DENG, P.O. BOX 26-757, TAIPEI, 106, TW

(21) Appl. No.: 10/881,641

(22) Filed: Jun. 28, 2004

(30) Foreign Application Priority Data
Jul. 24, 2003 (CN) 03267893.2

(51) Int. Cl. H01R 24/00

(52) U.S. Cl. 439/71

(57) ABSTRACT

A contact adopted for a socket has a base, an orientation arm, a resilient arm, and a solder portion. The resilient arm has a first portion extending from the base and a second portion upwards bent from the first portion, and the second portion of the resilient arm is parallel to the base as an inverse type with a straight, turning angle. Therefore, the contact is processed easily and simply and is further capable of a secure connection to a mating electronic device, and a contact resistance between the contact and the mating electronic device is reduced thereby to guarantee an effective electrical contact.

### BACKGROUND OF THE INVENTION

1. Field of the Invention

The present invention relates to a contact and a socket using the contact, and particularly relates to a contact capable of resilient compression and a socket using the contact.

2. Background of the Invention

There are several kinds of connection methods between a socket and a mating electronic device. A resilient compression connection with a contact is one kind of connection. A conventional contact illustrated in FIGS. 1, 2 includes a base 1, a contact arm 2 extending from the base 1 upwardly, a carrier-tape arm 3 bent from the contact arm 2, and a solder portion 4 bent from a bottom of the base 1 with a right angle. The solder portion 4 is used for welding a welding material, like a solder ball. A contact portion 6 slantwise extends upwardly from a top of the contact arm 2. In the assembly process, the conventional contact mates with an insulating housing 5, the base 1 is secured in a receiving slot 51 of the insulating housing 5, the contact portion 6 is exposed by the insulating housing 6, and the solder portion 4 aligns with a bottom of the insulating housing 5 to electrically connect a circuit board (not shown) via the conventional contact. The mating electronic device (not shown) can be placed above the contact portion 6 of the conventional socket, and further pressed downwardly to electrically connect the contact portion 6.

At least three shortcomings in these kinds of contact need to be overcome. First, to meet a predetermined height of the socket, the base must be designed to be short, so as to result in a slackened retention between the base of the insulating housing. Second, the contact portion has a tapered and bent end to contact the mating electronic device; thus a contact resistance between the mating electronic device and the tapered end is too large to influence the electrical connection therebetween. Third, the conventional contact is processed by pluralities of bending steps that waste time and costs.

Hence, an improvement over the prior art is required to overcome the disadvantages thereof.

### SUMMARY OF INVENTION

The primary object of the invention is therefore to specify a contact and a socket using the contact with an easy process and a secure connection that guarantees an effective electrical connection to a mating electronic device.

According to the invention, the object is achieved by a contact adopted for a socket. The contact includes a base, a resilient arm extending from a bottom of the base and being capable of bent inversely to surmount a top of the base, and a solder portion extending from the base, where the resilient arm has a distal portion that is over the top of the base opposite the base alternatively with a predetermined angle.

According to the invention, the object is achieved by a socket using the contact. The socket includes a bottom casing, a top cover pivotally connecting the bottom casing, an orientation stand arranged between the bottom casing and the top cover, and a lever capable of clamping with the bottom casing and the top cover. The orientation stand has an insulation housing and a plurality of contacts received in the insulation housing; each of the contacts includes a base, a resilient arm extending from a bottom of the base and being capable of bending inversely to surmount a top of the base, and a solder portion extending from the base.

To provide a further understanding of the invention, the following detailed description illustrates embodiments and examples of the invention. Examples of the more important features of the invention thus have been summarized rather broadly in order that the detailed description thereof that follows may be better understood, and in order that the contributions to the art may be appreciated. There are, of course, additional features of the invention that will be described hereinafter which will form the subject of the claims appended hereto.

### BRIEF DESCRIPTION OF THE DRAWINGS

These and other features, aspects, and advantages of the present invention will become better understood with regard to the following description, appended claims, and accompanying drawings, where:

FIG. 1 is a perspective view according to a conventional contact;

FIG. 2 is a cross-sectional profile of the conventional contact assembled in an insulating housing;

FIG. 3 is a perspective view of a socket combined with a PCB according to a first embodiment of the present invention;

FIG. 4 is a perspective view of a contact according to the first embodiment of the present invention;

FIG. 5 is a cross-sectional profile of the contact after assembly with an insulating housing according to the first embodiment of the present invention;

FIG. 6 is a perspective view of the contact according to a second embodiment of the present invention;

FIG. 7 is a cross-sectional profile of the contact assembled with the insulating housing according to a third embodiment of the present invention; and

FIG. 8 is a cross-sectional profile of the contact assembled with the insulating housing according to a fourth embodiment of the present invention.

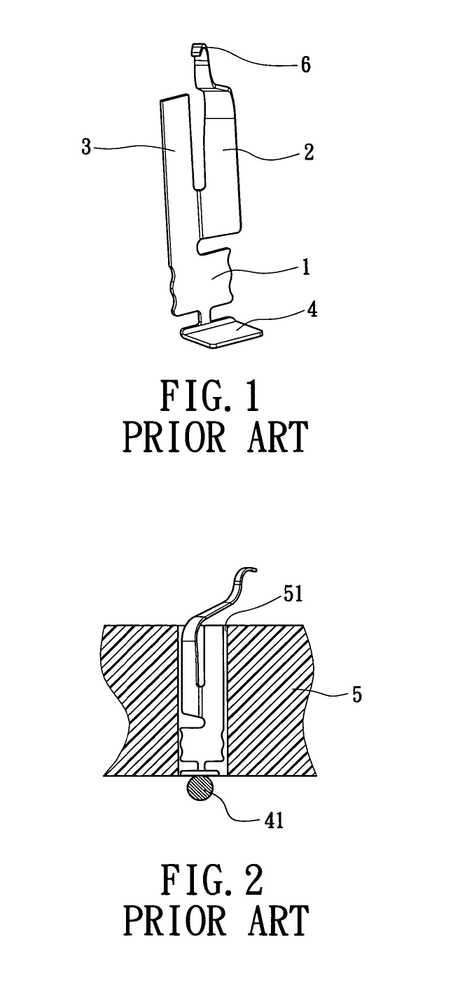

### DETAILED DESCRIPTION OF THE EMBODIMENTS

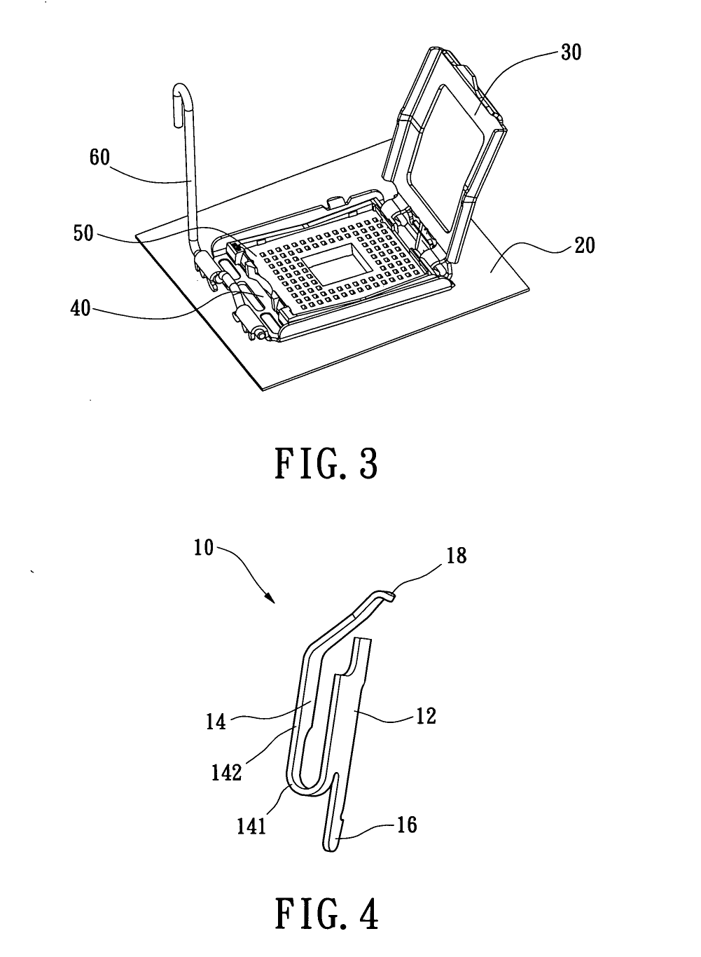

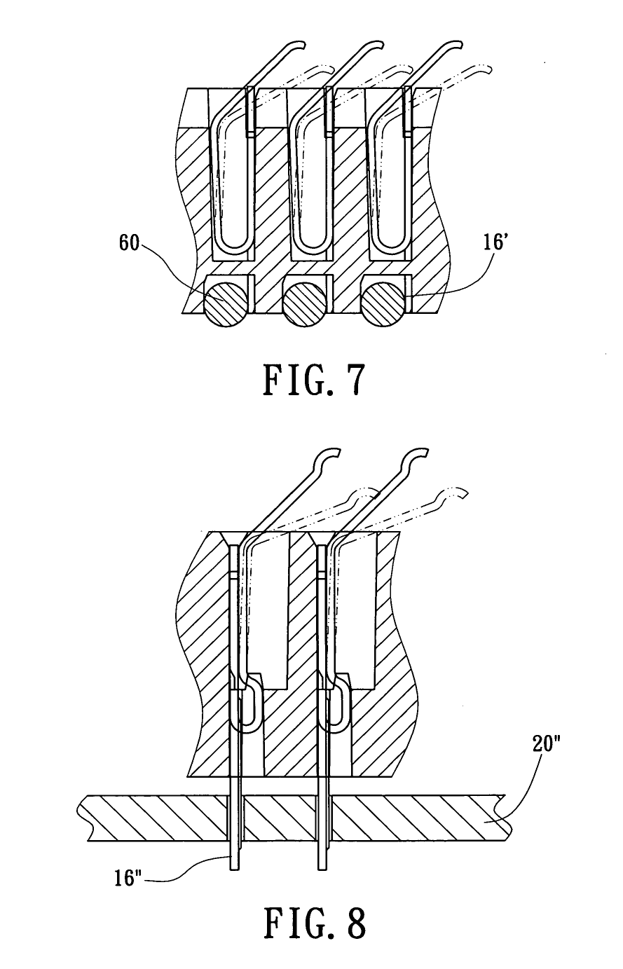

FIGS. 3 to 5 illustrate a contact 10 adopted for a socket according to the present invention, including a base 12, a resilient arm 14 extending from a bottom of the base 12 and being capable of bending inversely to surmount a top of the base 12, and a solder portion 16 extending from the base 12. The resilient arm 14 has a distal portion 18 over the top of the base 12 opposite the base 12 alternatively with a predetermined angle. In this embodiment, the distal portion 18 bends towards the base 12. The distal portion 18 of the resilient arm 14 is capable of being resiliently compressed to retain against the base 12 by a mating electronic device (not shown). The resilient arm 14 further has a curved portion 141 extending from the bottom of the base 12 and bent upwards, and a lengthening portion 142 extending from the curved portion 141 and parallel to the base 12; the distal end 18 connects the lengthening portion 142. The solder portion 16 extends from a bottom of the base 12, and the solder portion 16 can abut against a PCB 20 with a direct electrical connection, be welded to the PCB 20 in FIG. 4, connect a solder material 60 in advance (shown in FIG. 6), and penetrate through the PCB 20 (shown in FIG. 7) in a selective manner. According to the present invention, the socket includes a bottom casing 40, a top cover 30 pivotally connecting the bottom casing 40, an orientation stand 50 arranged between the bottom casing 40 and the top cover 30, and a lever 60 being capable of clamping with the bottom casing 40 and the top cover 30. The orientation stand 50 has an insulation housing 54 and a plurality of holes 52 formed in the insulation housing 54. In assembly, the contact 10 is secured in each of the holes 52 of the insulation housing 54, and the solder portion 16 and the distal portion 18 exceed the lower and upper surfaces of the insulation housing 54 to connect electrically the PCB 20 and the mating electronic device, respectively. When the contact 10 connects the mating electronic device, the mating electronic device compresses the resilient arm 14 downwardly to contact effectively the contact 10. The contact 10 can be designed to abut against the base 12 to improve the security and a direct force to the mating electronic device.

Because of the extension of the resilient arm 14, the resilient arm 14 can be designed with a height equivalent to that of the insulation housing 54 to improve the security therein. Because the resilient arm 14 is long enough to provide excellent elasticity to stand pluralities of compression, the contact 10 is extremely simple to manufacture.

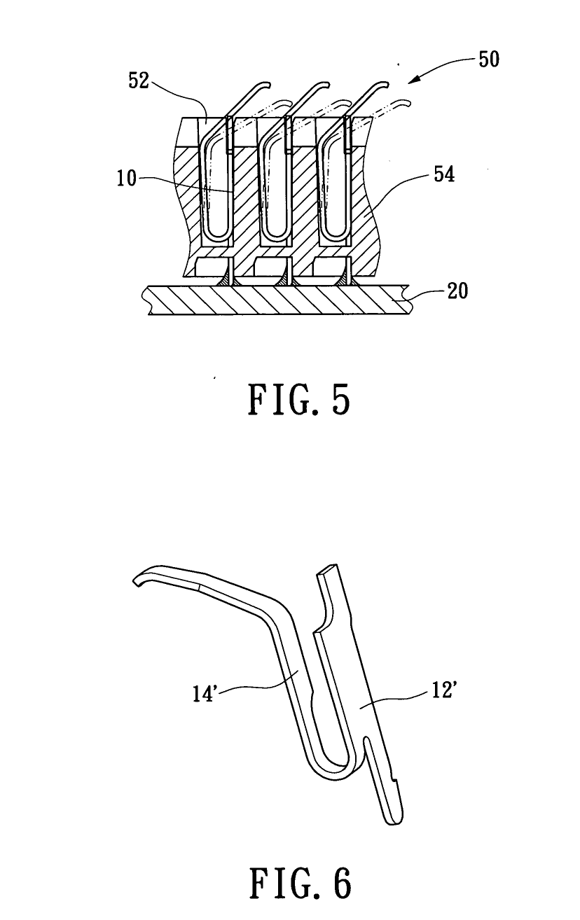

The contact 10 according to the present invention can be shaped in various configurations to meet the same requirements. FIG. 5 shows a distal portion 18′ opposite a base 12′. FIG. 6 shows a solder material 60 adhered to a soldering portion 16′ in advance for better connection to a PCB 20′. FIG. 7 illustrates a soldering portion 16″ to penetrate through a PCB 20″ for a welding connection.

It should be apparent to those skilled in the art that the above description is only illustrative of specific embodiments and examples of the invention. The invention should therefore cover various modifications and variations made to the herein-described structure and operations of the invention, provided they fall within the scope of the invention as defined in the following appended claims.

1. A contact adopt for a socket comprising:
a base;
a resilient arm extending from a bottom of the base and being capable of bending inversely to surmount a top of the base; and
a solder portion extending from the base;
wherein the resilient arm has a distal portion over the top of the base opposite the base alternatively with a predetermined angle.

2. The contact as claimed in claim 1, wherein the resilient arm is capable of being resiliently compressed to be retained against the base.

3. The contact as claimed in claim 1, wherein the solder portion extends from a bottom of the base, the solder portion is capable of abutting against a PCB with a direct electrical connection, welding to the PCB, connecting a solder material in advance, and penetrating through the PCB in a selective manner.

4. The contact as claimed in claim 1, wherein the resilient arm has a curved portion extending from the bottom of the base and bent upwards, and a lengthening portion extending from the curved portion and parallel to the base; the distal end connecting to the lengthening portion.

5. A socket accommodating with a contact, comprising:
a bottom casing;
a top cover pivotally connecting to the bottom casing;
an orientation stand arranged between the bottom casing and the top cover, the orientation stand having an insulation housing and a plurality of contacts received in the insulation housing, wherein each of the contacts includes a base, a resilient arm extending from a bottom of the base and being capable of bending inversely to surmount a top of the base, and a solder portion extending from the base; and
a lever being capable of clamping with the bottom casing and the top cover.

6. The socket as claimed in claim 5, wherein the resilient arm has a distal portion over the top of the base opposite the base alternatively with a predetermined angle.

7. The socket as claimed in claim 5, wherein the resilient arm is capable of being resiliently compressed to be retained against the base.

8. The socket as claimed in claim 5, wherein the solder portion extends from a bottom of the base, the solder portion is capable of abutting against a PCB with a direct electrical connection, being welded to the PCB, connecting a solder material in advance, and penetrating through the PCB in a selective manner.

9. The socket as claimed in claim 5, wherein the resilient arm has a curved portion extending from the bottom of the base and bent upwards, and a lengthening portion extending from the curved portion and parallel to the base, and wherein the distal end connects the lengthening portion.
